(19) United States
(12) Patent Application Publication
(10) Pub. No.: US 2015/0015048 A1
(43) Pub. Date: Jan. 15, 2015

(54) FOLDING MECHANISM FOR A HEAD RESTRAINT

(71) Applicant: Johnson Controls Technology Company, Holland, MI (US)

(72) Inventors: Michael KAPUSKY, Milan, MI (US); Patrick DONNELLY, Brighton, MI (US); David HAYES, West Bloomfield Township, MI (US); Srinivasa SANKU, Northville, MI (US); Alexander BALIN, Ann Arbor, MI (US)

(21) Appl. No.: 14/328,319

(22) Filed: Jul. 10, 2014

Related U.S. Application Data
(60) Provisional application No. 61/845,323, filed on Jul. 11, 2013.

(51) Int. Cl. B60N 2/48

(52) U.S. Cl. CPC B60N 2/487; B60N 2/4841
USPC 297/408; 297/463.1; 29/428

(57) ABSTRACT

A folding mechanism for a head restraint may include a support member and a latch. The support member may have a first axis and a projection that projects outward from the support member. The latch may be attached to the head restraint and rotatable around the first axis and may have a notch that can receive the projection. The latch may be flexed to pivot a portion of the latch around a second axis in order to move between an unlocked position where the projection is not received in the notch such that the head restraint is rotatable around the support member, and a locked position where the projection is received in the notch such that the head restraint is not rotatable around the support member.

### CROSS-REFERENCE TO RELATED PATENT APPLICATION

This application claims priority to and the benefit of U.S. Provisional Patent Application No. 61/845,323, filed Jul. 11, 2013, the entire disclosure of which is incorporated herein by reference.

### FIELD

The disclosure relates generally to folding mechanisms for use in adjustable devices, such as, for example, a folding mechanism for a head restraint that accommodates original equipment manufacturer (OEM) packaging and provides rear visibility.

### BACKGROUND

The size of head restraints in vehicle seats have increased due to stricter global safety requirements. Therefore, it is desirable to enable the head restraints to have folding mechanisms in order to maximize rear visibility when no occupant is in the seat.

### SUMMARY

According to one embodiment of the present invention, a folding mechanism for a head restraint may include a support member and a latch. The support member may have a first axis and a projection that projects outward from the support member. The latch may be attached to the head restraint and rotatable around the first axis and may have a notch that can receive the projection. The latch may be flexed to pivot a portion of the latch around a second axis in order to move between an unlocked position where the projection is not received in the notch such that the head restraint is rotatable around the support member, and a locked position where the projection is received in the notch such that the head restraint is not rotatable around the support member.

According to another embodiment of the present invention, a head restraint assembly movable with respect to a seat may include a head restraint, at least one head restraint tube extending from the seat, a support member and a latch. The support member may be attached to the at least one head restraint tube and may have a first axis. A projection may project outward from the support member. The latch may be attached to the head restraint and rotatable around the first axis and may have a notch that can receive the projection. The latch may be flexed to pivot a portion of the latch around a second axis in order to move between an unlocked position where the projection is not received in the notch such that the head restraint is rotatable around the support member, and a locked position where the projection is received in the notch such that the head restraint is not rotatable around the support member.

According to yet another embodiment of the present invention, a method of manufacturing a folding mechanism for adjusting a head restraint relative to a seat may include attaching a top portion of the latch to the head restraint and inserting a support member of a head restraint into a hole within a latch. The method may further include moving a projection on the support member into a notch on the latch and attaching a head restraint cover around at least the latch.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Features, aspects, and advantages of the present invention will become apparent from the following description, appended claims, and the accompanying exemplary embodiments shown in the drawings, which are briefly described below.

FIG. 1 is a perspective view of a vehicle according to one embodiment of the present invention.

FIG. 2 is a perspective view of the vehicle seat of FIG. 1.

FIG. 3 is a view of a head restraint assembly with a folding mechanism according to one embodiment of the present invention.

FIGS. 4A and 4B are side views of the head restraint assembly of FIG. 3 in a folded position and a locked position, respectively.

FIG. 5 is a side view of the head restraint assembly of FIG. 3 in a low pivot setup.

FIG. 6 is a side view of the head restraint assembly of FIG. 6 in a tilt setup.

FIG. 7 is a perspective view of a folding mechanism within a head restraint cover according to one embodiment of the present invention.

FIG. 8 is a perspective view of the folding mechanism of FIG. 7.

FIG. 9 is a front view of the folding mechanism of FIG. 7 in a locked position.

FIG. 10 is a front view of the folding mechanism of FIG. 7 in an unlocked position.

FIG. 11 is a perspective view of the folding mechanism of FIG. 7 with a release mechanism.

FIG. 12 is a top view of the folding mechanism of FIG. 7.

FIG. 13 is a close-up view of the folding mechanism of FIG. 12.

FIG. 14 is a cross-sectional view through Section A-A of the folding mechanism of

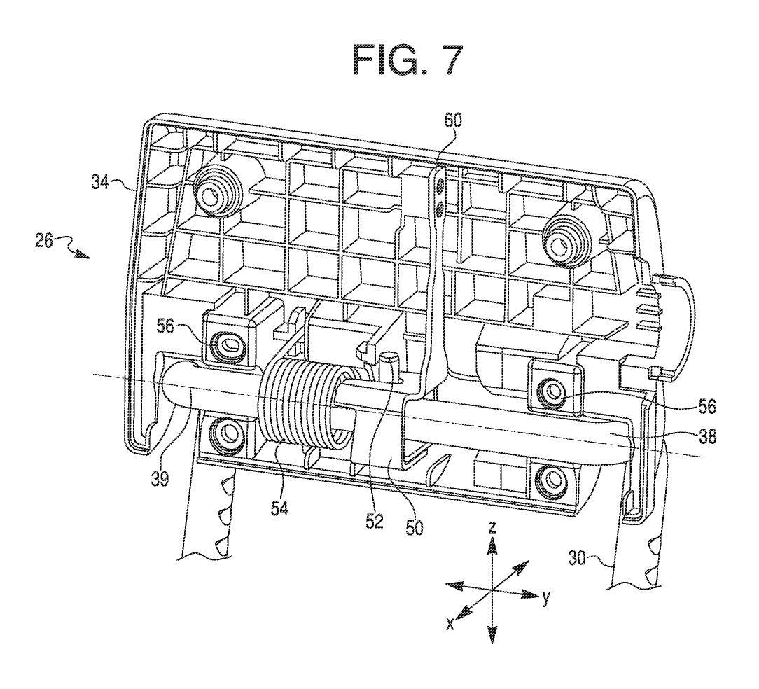

FIG. 7.

FIG. 15 is a perspective view of the folding mechanism of FIG. 7 in a folded position.

FIG. 16 is a perspective view of a folding mechanism according to another embodiment of the present invention.

FIG. 17 is a first perspective view of the latch of the folding mechanism of FIG. 16.

FIG. 18 is a second perspective view of the latch of FIG. 16.

FIG. 19 is a perspective view of a spring plate within the latch of FIG. 16.

FIG. 20 is a right-side view of the folding mechanism of FIG. 16.

FIG. 21 is a front view of the folding mechanism of FIG. 16.

FIG. 22 is a cross-sectional view through Section C-C of the folding mechanism of FIG. 21.

FIG. 23 is a close-up view of the folding mechanism of FIG. 22.

FIG. 24 is a cross-sectional view through Section B-B of the folding mechanism of FIG. 21.

FIG. 25 is a left-side view of the folding mechanism of FIG. 16.

FIG. 26 is a front view of the folding mechanism of FIG. 16 in a locked position.

FIG. 27 is a front view of the folding mechanism of FIG. 16 in an unlocked position.

FIG. 28 is a perspective view of the folding mechanism of FIG. 16 in an unlocked position.

FIG. 29 is a perspective view of the folding mechanism of FIG. 16 in a folded position.

FIGS. 30A-30C are perspective views of the folding mechanism being moved between a locked position and an unlocked position according to one embodiment.

### DETAILED DESCRIPTION

Referring generally to the figures, disclosed herein is a latch mechanism or folding mechanism for a head restraint, as shown according to exemplary embodiments. The present disclosure relates generally to a folding mechanism for use in coupling a first member to a second member and allowing one member to either lock or move relative to the second member. In one exemplary embodiment, the folding mechanism may allow a head restraint to be either in a locked position or an unlocked position with respect to other components within the vehicle, such as the vehicle seat or the head restraint support tubes (which may be attached to a vehicle seat). Accordingly, while the folding mechanism is in the unlocked position (e.g. upon the release and/or unlocking of the folding mechanism), the user may selectively control the position and movement (e.g. rotation, tilt, etc.) of the head restraint and may fold or tilt the head restraint between a first position and a second position. For example, the head restraint may be moved between folded and upright positions. Alternatively or additionally, the folding mechanism may be used as a tilt mechanism to tilt the head restraint. Once the head restraint has been moved to the desired position, the folding mechanism may lock the head restraint in the desired position, such as an upright configuration, into the locked position. In the locked position, the head restraint position may be fixed.

The folding mechanism and methods described herein may be used in a variety of moving and locking applications and methods. For example, the folding mechanism may be used to move, pivot, and/or lock head restraints or vehicle seat rows. The folding direction and amount of travel may vary according to the desired configuration. The folding mechanism may also be useful in any non-vehicle application wherein it would be desirable to use a folding mechanism to control the latching of two members or elements.

The head restraint folding mechanism may allow the vehicle seat to be folded without head restraint removal and may accommodate original equipment manufacturer (OEM) packaging constraints. While a head restraint with the folding mechanism is locked in its upright position, the head restraint is fully functional and meets the targeted performance required by various OEM and global safety requirements. Further, the folding mechanism provides a lower cost and lower mass solution to allow the head restraint to be movable and lockable.

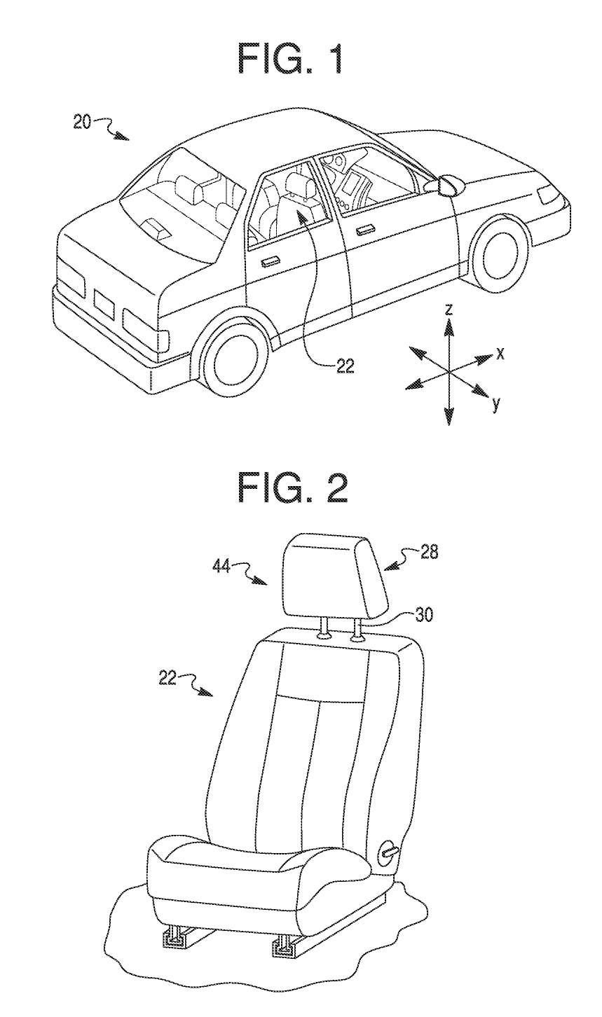

FIG. 1 illustrates an exemplary embodiment in which the folding mechanism may be placed in a vehicle 20. The vehicle 20 may include an interior passenger compartment containing a vehicle seat 22 for providing seating to an occupant. Although a four door sedan automobile is shown in FIG. 1, the folding mechanism may be used in a variety of applications, but are particularly useful within a head restraint in any type of vehicle, such as a two door or four door automobile, a truck, a SUV, a van, a train, a boat, an airplane, or other suitable vehicular conveyance.

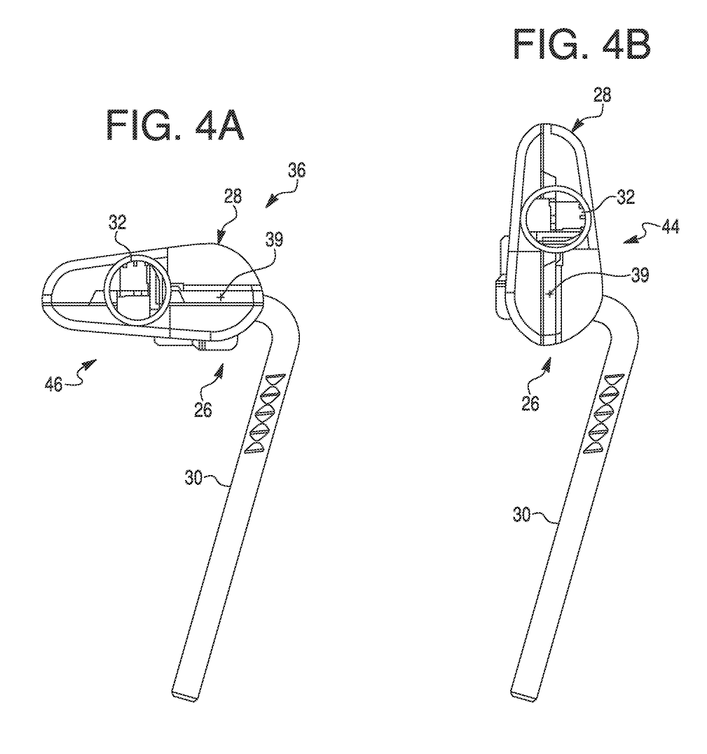

According to one embodiment of the present invention as depicted in FIG. 2, a head restraint 28 may be mounted to the vehicle seat 22 by a head restraint tube 30. The folding mechanism of the present invention is particularly useful for locking and unlocking the head restraint 28. When the head restraint 28 is unlocked, the head restraint 28 may be moved between, for example, a locked position 44 (which may also be upright, as shown in FIGS. 2 and 4B) and a folded position 46 (shown in FIG. 4A). The folded position 46 may be locked or unlocked, according to the desired configuration.

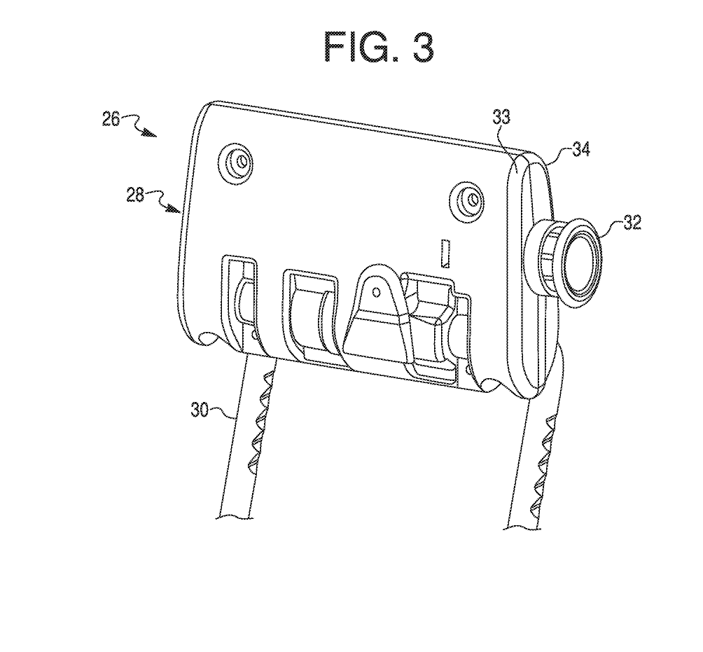

Referring to FIG. 3, there is shown a head restraint assembly, which may include a head restraint mechanism or folding mechanism 26 according to one embodiment and a head restraint 28 connected to a head restraint tube 30. The foam and trim that are optionally associated with the head restraint 28 and may cover the folding mechanism 26 is removed from FIG. 3 for clarity. A front cover 33 and a rear cover 34 may be used to protect the head restraint 28 and provide structure within the head restraint 28. The covers 33 and 34 may be constructed out of a variety of materials, including but not limited to plastic or metal. A release mechanism 32, as described further herein, may be integrated into the head restraint 28 for use with the folding mechanism 26.

The folding mechanism 26 may be used to allow the head restraint 28 to move in a variety of different ways, directions, amounts, and axes, according to the desired configuration. With each of the head restraint assemblies, the folding mechanism 26 may allow the head restraint 28 (and/or the head restraint tubes 30) to fold, move, pivot, or tilt any number of degrees. For example, with the folding mechanism 26, the head restraint 28 may be moved 180 degrees relative to either the head restraint tube 30 or the vehicle seat 22 in either a forward or rearward direction. The folding mechanism 26 may also allow the head restraint 28 (and/or the head restraint tubes 30) to be locked or secured into multiple different positions or angles, according to the desired configuration.

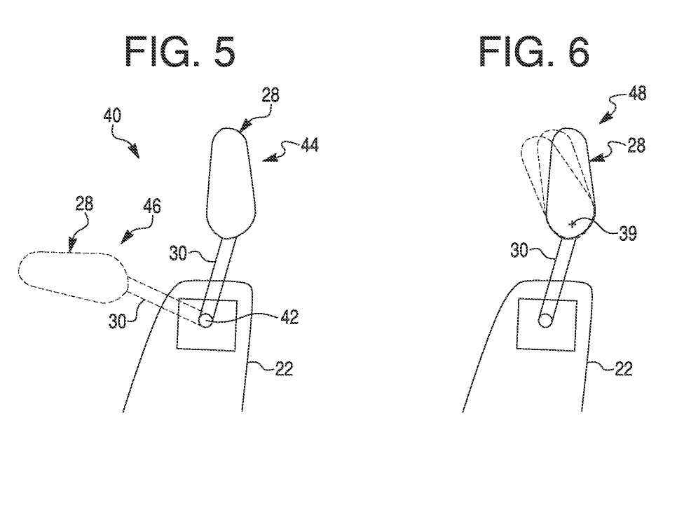

It may be beneficial to fold the head restraint 28 out of the way when no occupant is seated (in order to, for example, fold the vehicle seat 22 or to maximize rear visibility), as shown in FIGS. 4-5. It may also be beneficial to tilt the head restraint 28 in order to provide support to the occupant, as shown in FIG. 6.

According to one embodiment, the folding mechanism 26 may allow the head restraint 28 to have a high pivot setup 36, as shown in FIGS. 4A and 4B. With the high pivot setup 36, the folding mechanism 26 may be configured to allow the head restraint 28 to fold or rotate relative to the head restraint tubes 30 any number of degrees, according to the desired configuration. The axis of rotation may be within the head restraint 28. FIG. 4A depicts the head restraint 28 in a folded position 46, in which the head restraint 28 is folded forward at approximately 90 degrees relative to the upright position in FIG. 4B. FIG. 4B depicts the head restraint 28 in an upright and locked position 44, in which the head restraint 28 is fully functional and able to be used by a passenger.

Alternatively or additionally, the folding mechanism 26 may allow the head restraint 28 to have a low pivot setup 40, as seen in FIG. 5. With a low pivot setup 40, the head restraint 28 may be moved with at least a portion of the head restraint tubes 30 between a locked position 44 and a folded position 46, relative to the vehicle seat 22. As shown, the head restraint 28 pivots around a pivot axis 42 that is within the vehicle seat 22. The high pivot setup 36 and the low pivot setup 40 may be used together in the same head restraint assembly.

Alternatively or additionally, the folding mechanism 26 may allow the head restraint 28 to have a tilt setup 48, as shown in FIG. 6. With the tilt setup 48, the head restraint 28 may tilt forward or backward and lock in multiple positions relative to the head restraint tube 30 so as to position the head restraint 28 in the position desired by the seat occupant during use. The axis of rotation may also be within the head restraint 28.

The folding mechanism 26 may be used within the head restraint assembly of any of the embodiments shown in FIGS. 2, 3, 4A, 4B, 5, and/or 6. The head restraint assembly may include the head restraint 28, at least one head restraint tube 30 (extending from the vehicle seat 22), and the folding mechanism 26. The folding mechanism 26 may include a support member 38 and a one-piece latch 50. The folding mechanism 26, however, is not limited to the head restraint assembly and may be used in conjunction with other components or fixtures.

As shown in FIG. 7, the cover 34 of the head restraint 28 may include pivot axis bearing surfaces 56 to allow the head restraint 28 and folding mechanism 26 to be supported by the support member 38 or head restraint tube 30, while being free to pivot about the support member 38. The cover 33 may also have pivot axis bearing surfaces around the support member 38 (however, only the rear cover 34 is shown in FIG. 7 and the front cover 33 is hidden to illustrate the positioning of the folding mechanism 26 with respect to the rear cover 34).

The support member 38 may hold or support the head restraint 28 and allow the head restraint 28 to move between positions. As described further herein, the support member 38 may also interact with the latch 50 to allow the head restraint 28 to be locked into different positions.

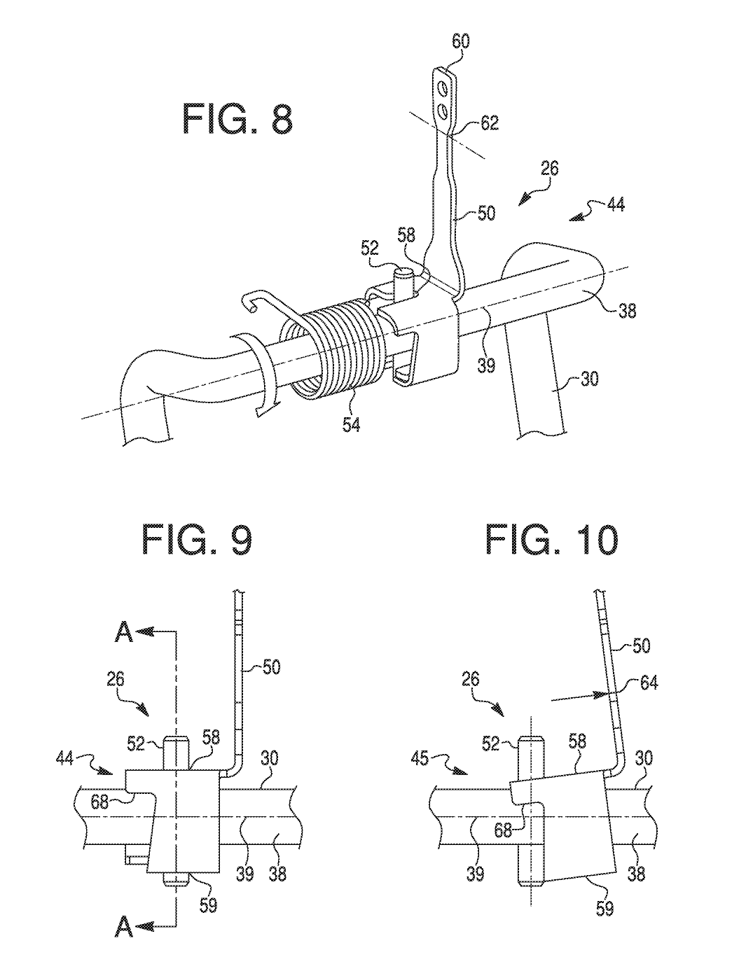

According to one embodiment as shown in FIGS. 7 and 8, the support member 38 may be an extension or part of the head restraint tubes 30. For example, the support member 38 may be a horizontal portion or tube extending along the length of the head restraint 28 and between two head restraint tubes 30. The head restraint tubes 30 may extend between the head restraint 28 and the vehicle seat 22. However, it is anticipated that the support member 38 may be any component that allows the head restraint to move and may be oriented in any direction. Both the front and rear covers 33 and 34 have been removed in FIG. 8 to show the folding mechanism 26.

The head restraint 28 may rotate around at least a portion of the support member 38. Accordingly, the support member 38 may define a first axis 39 or pivot point for the head restraint 28 to rotate, pivot, or move around. For example, the support member 38 may extend along approximately the y-axis (the lateral direction), while the head restraint tubes 30 may extend along approximately the z-axis (the vertical direction). Accordingly, the head restraint 28 may rotate around approximately the y-axis.

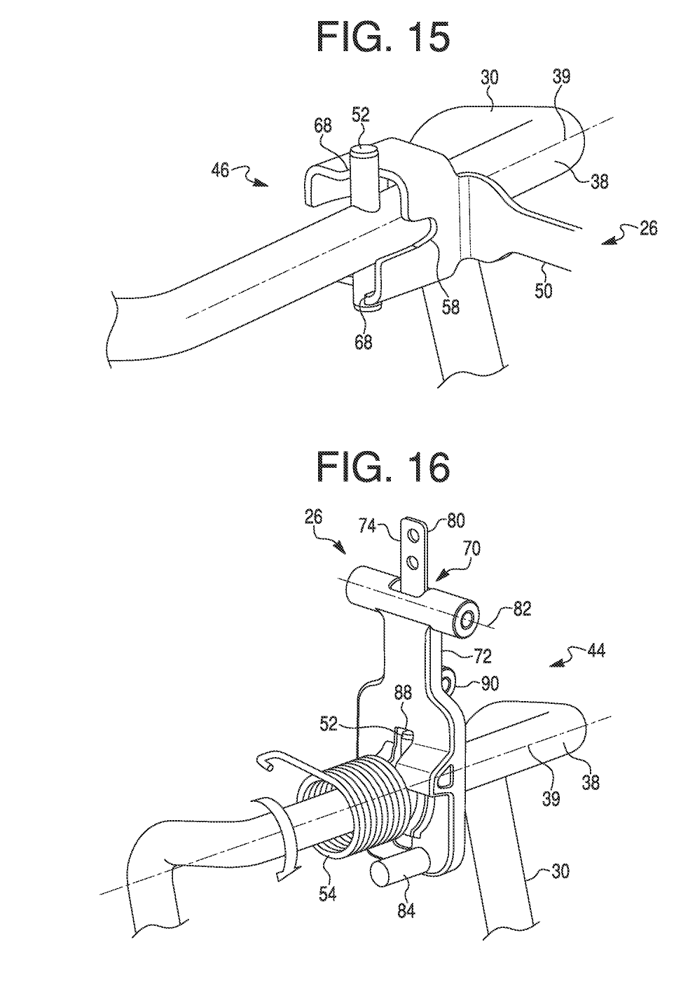

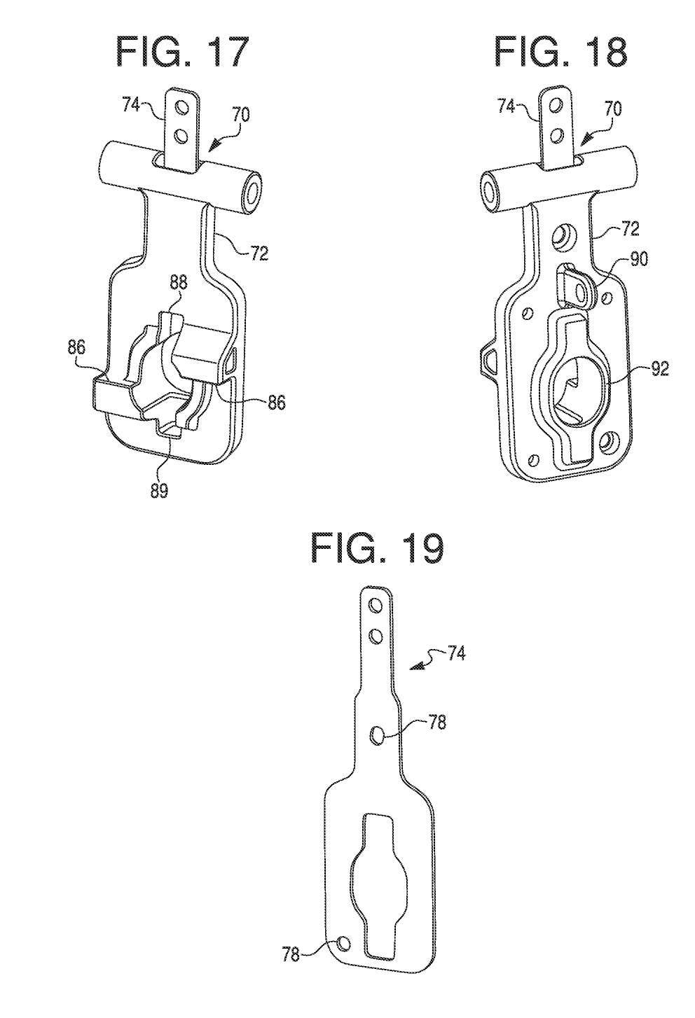

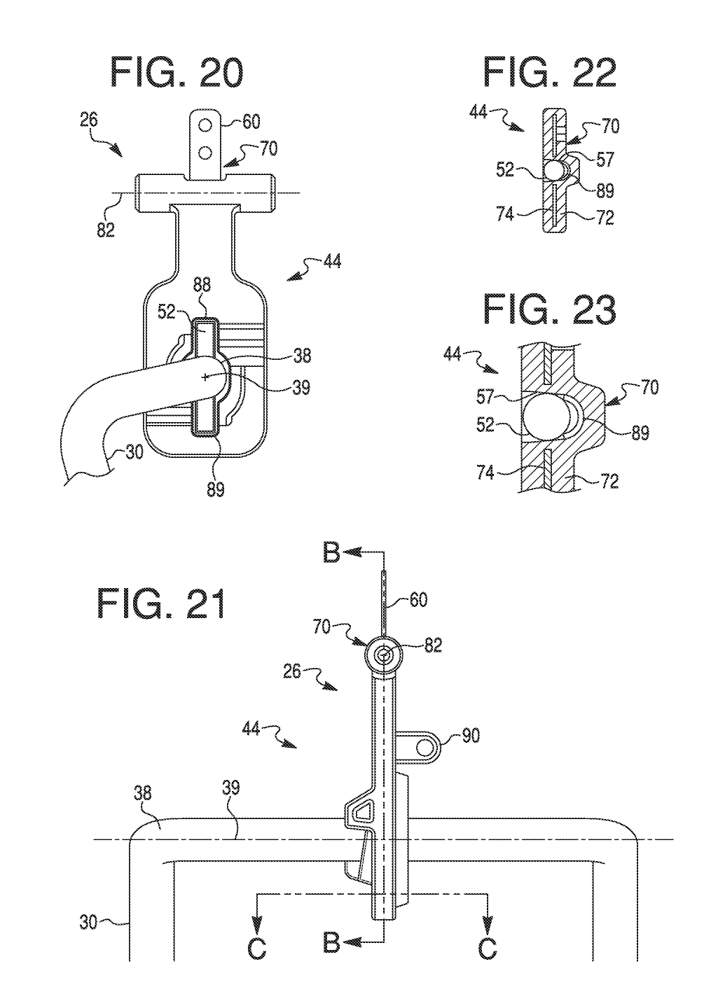

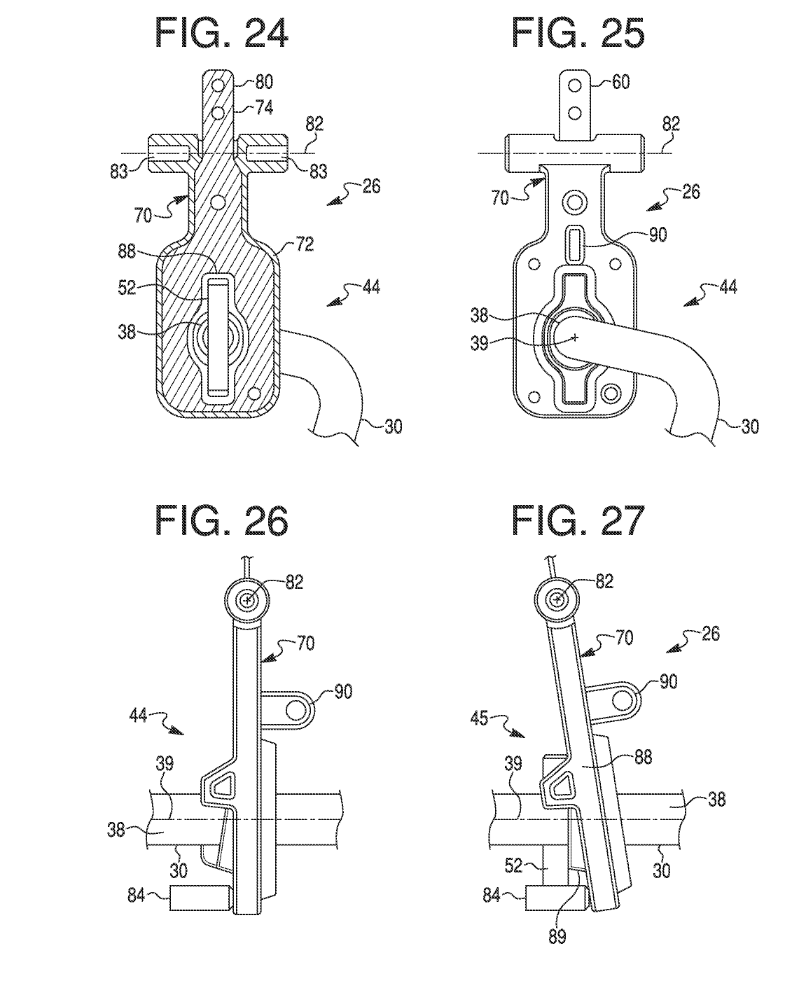

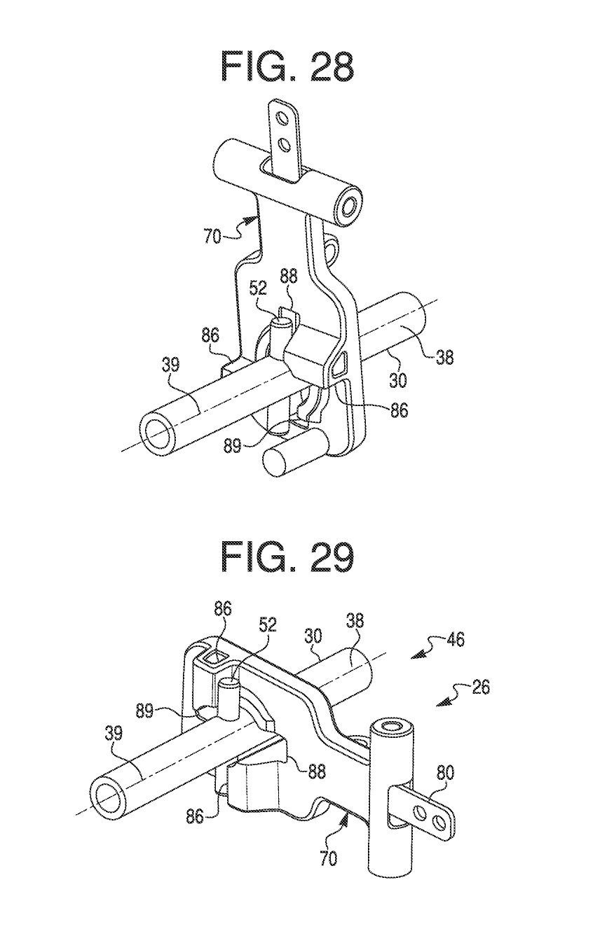

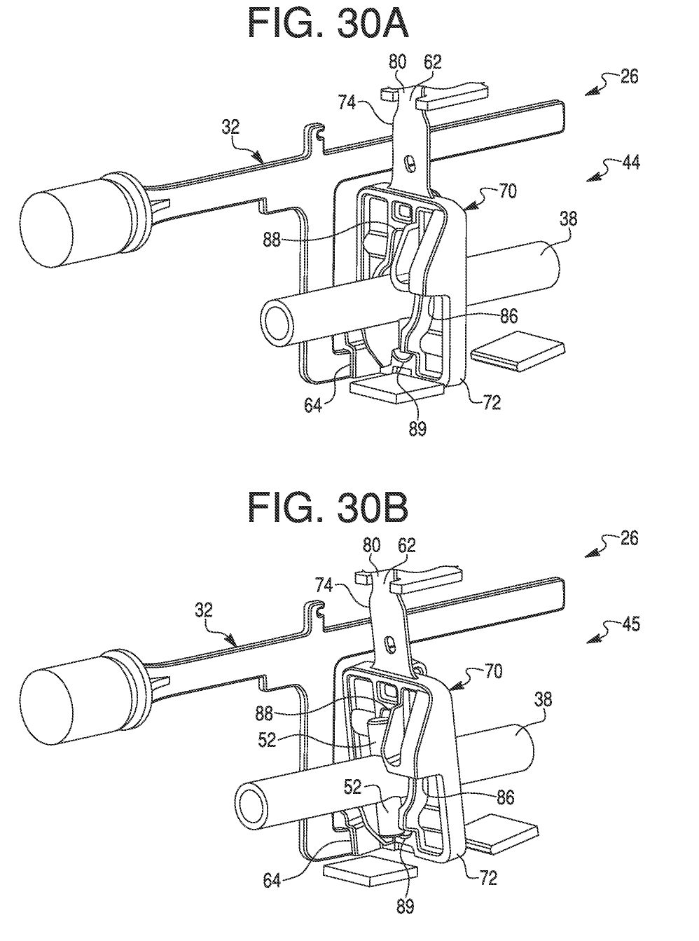

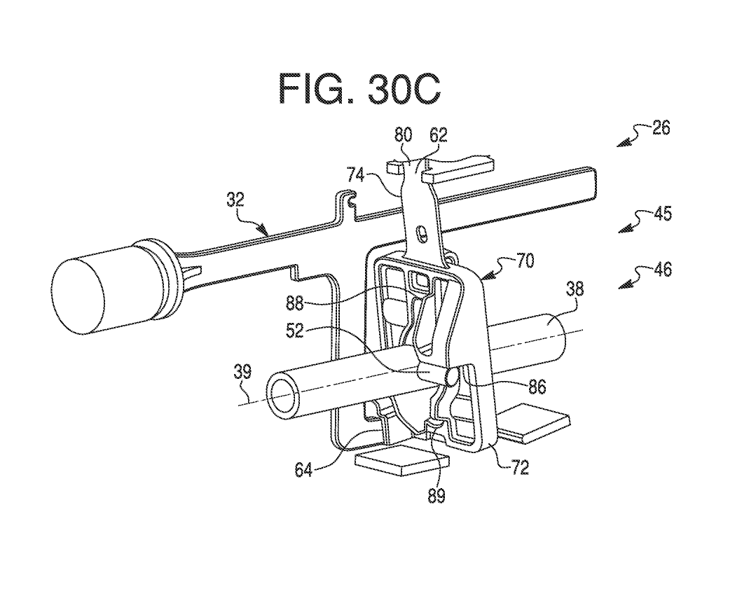

The support member 38 may include at least one lock pin or projection 52 to interact with the latch 50. The projection 52 may extend or project outward from the support member 38 in the x-z plane. The projection 52 may be formed integrally with the support member 38 or it may be attached thereto. As shown in FIG. 14, the projection 52 may be press-fit into holes in the support member 38 to secure the projection 52 as the folding mechanism 26 pivots around the head restraint tube 30 and locks with the projection. The projection 52 may project from opposite sides of the support member 38, such as by extending through the support member 38.

As shown in FIGS. 7 and 8, the folding mechanism 26 may include the latch 50 to interact with the support member 38 and lock the head restraint 28 into place. The latch 50 may function as both a mechanism lock and a lock spring, thereby eliminating the need for a separate spring to apply the locking force. The packaging of the folding mechanism 26 and, more specifically, the latch 50, simplifies the ability to release the locking mechanism of the head restraint 28, allowing the head restraint assembly to be a lower cost and lower mass design.

In order to lock and unlock the latch 50 to the support member 38 and to function as a lock spring, the latch 50 may be flexed relative to the support member 38. Accordingly, the latch 50 may be constructed out of a flexible material, including but not limited to metal (such as spring steel) or plastic. The latch 50 may be moved or temporarily deformed and may return to its original configuration and geometry.

The latch 50 may extend in a lengthwise direction and may have a first end and a second end. The first end and second end may be on opposite ends along the lengthwise direction of the latch 50.

As shown in FIGS. 7 and 8, the first end of the latch 50 may be attached or fixed to a portion of the head restraint 28, such as the rear cover 34. Since the latch top 60 is attached to the head restraint 28, the head restraint 28 may move with the latch 50 to adjust the position of the head restraint 28. According to one embodiment, the first end of the latch 50 may be the latch top 60. Accordingly, the latch top 60 may be fixed at the top of the rear cover 34 or the front cover 33 of the head restraint 28.

The latch top 60 may be statically attached to the head restraint 28, such that the latch top 60 and the head restraint 28 do not move relative to each other. However, it is anticipated that the latch top 60 may be attached to the head restraint 28 in such a way as to allow the latch top 60 to move relative to the head restraint 28. The latch top 60 may be attached or fixed to the head restraint 28 through a variety of different mechanisms, including features in the plastic covers 33 or 34, screws, or bolts. The head restraint 28 may have an inner feature or protrusion to function as a fulcrum for the latch 50 to bend or flex at least partially around, defining the second axis 62. As described further herein, as the latch 50 moves around the second axis 62, the latch 50 may be moved between the locked position 44 and the unlocked position 45.

The support member 38 may extend through a portion or hole, such as the latch cover or sides 66, along the second end of the latch 50 to allow the latch 50 to rotate about the first axis 39 within support member 38 in order to change the position of the head restraint 28. The diameter or height of the portion or hole of the latch 50 may be sufficiently larger than the diameter or height of the support member 38 to allow the second end of the latch 50 to move relative to the support member 38. As shown in FIG. 14, the latch sides 66 may provide additional support for each side of the latch 50 during significant loading or strength testing. During normal operation, there may be clearance around the support member 38 for the latch sides 66.

Due to the nature of the latch 50 (e.g. the flexibility of the spring steel), the latch 50 may be flexed, as shown in FIGS. 9 and 10, and the second end of the latch 50 may move relative to both the head restraint 28 and the support member 38 in order to move the folding mechanism 26 between a locked position 44 and an unlocked position 45, as described further herein. For example, flexing the latch 50 may unlock the latch 50 from the support member 38.

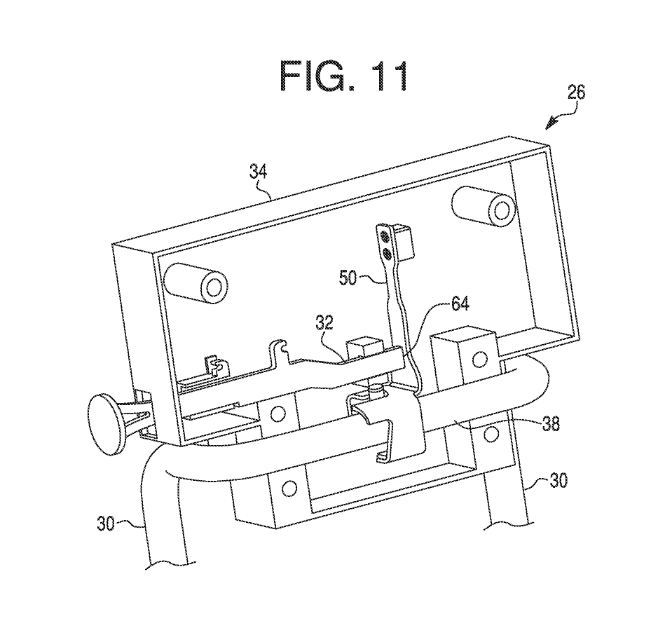

In order to flex the latch 50 to lock and unlock (or release) the folding mechanism 26, a release device or mechanism 32 may be used and integrated into the head restraint 28, as shown in FIGS. 11 and 30A-30C. When the release mechanism 32 is activated to unlock the folding mechanism 26, the latch 50 may flex to unlock the folding mechanism 26 and the position of the head restraint 28 may be adjusted relative to the head restraint tube 30 or the vehicle seat 22. The release mechanism 32 may move the latch 50 by applying a force to the latch 50. When the latch 50 is pushed or pulled by this force, the latch 50 flexes or bends and moves with respect to both the head restraint 28 and the support member 38. When the latch 50 is flexed, the folding mechanism 26 may unlock to move the head restraint 28, as described further herein.

A variety of different mechanisms may be used within the release mechanism 32. For example, the release mechanism 32 may push or pull the latch 50 in order to cause the latch 50 to flex. The latch 50 may accommodate any release mechanism 32, including but not limited to a push button, a cable, a strap, or a handle.

As shown in FIGS. 11 and 30A-30C, the release mechanism 32 may an extending post attached to a push button. When the push button is pushed by the user, the release mechanism 32 may transfer the force to the latch 50 by pushing the latch 50. According to another embodiment, the release mechanism 32 may be a cable release that pulls the latch 50. Since the latch 50 is statically attached to the head restraint 28, the latch 50 will flex with the force from the release mechanism 32 and the second end of the latch 50 will move relative to the first end (the latch top 60).

As shown in FIGS. 10 and 11, the latch may further have a push/pull point 64 that provides an area for the latch 50 to be either pushed or pulled via the release mechanism 32.

The release mechanism 32 may interact with any portion of the latch 50 and the push/pull point 64 may be located anywhere along the latch 50. For example, as shown in FIG. 11, the release mechanism 32 may contact the latch 50 (at the push/pull point 64) on the same side of the support member 38 as the latch top 60 (e.g. the attachment point of the latch 50 to the cover 34). According to another embodiment as shown in FIGS. 30A-30B, the push/pull point 64 may be on the opposite side of the support member 38 as the latch top 60 (or, as shown, the latch top 80).

In order to lock and unlock the latch 50, the latch 50 may interact with the projection 52 on the support member 38. For example, as shown in FIG. 8, the latch 50 may include at least one notch 58 along the second end to engage with and lock onto the projection 52. The notch 58 may be, for example, a divot or recess within the second end of the latch 50. The notch 58 may be sized, shaped, and configured to receive the projection 52.

As shown in FIGS. 8, 9, and 30A, the projection 52 may fit into, engaged with, received within or positioned within the notch 58 of the latch 50, thereby securing the folding mechanism 26 in the locked position 44 and preventing the folding mechanism 26 from pivoting around the support member 38 of the head restraint tube 30. Therefore, in the locked position 44, the folding mechanism 26 (and, therefore, the head restraint 28) may be held and locked into place around the support member 38 and is not rotatable with respect to the support member 38.

In order to release the projection 52 from the notch 58 so that the position of the head restraint 28 may be changed or adjusted, the release mechanism 32 may push or pull the latch 50 to flex and move the second end of the latch 50, which moves the folding mechanism 26 out of the locked position 44 and into the unlocked position 45, as shown in FIG. 30B. When the latch 50 is flexed, the notch 58 may be moved away or out from the projection 52, thereby releasing or disengaging the projection 52 from the notch 58. When the notch 58 and the projection 52 are separated or released from each other (or the projection 52 is not received within the notch 58), the folding mechanism 26 (and, therefore, the head restraint 28) is in the unlocked position 45 and may be free to pivot, move, or rotate around at least a portion of the support member 38 of the head restraint tube 30. Further, in the unlocked position 45, the folding mechanism 26 (and, therefore, the head restraint 28) may be moved into the folded position 46, as shown in FIGS. 15 and 30C. As described further herein, a spring 54 may bias and automatically move the folding mechanism 26 toward the folded position 46 once the folding mechanism 26 is unlocked and able to pivot around the first axis 39.

When the latch 50 is flexed or bent, the latch 50 may pivot about a latch bend point or second axis 62. The second axis 62 may be approximately perpendicular to the first axis 39. For example, the first axis 39 may approximately extend along the y-axis and the second axis 62 may approximately extend along the x-axis (the longitudinal direction). Accordingly, when the latch 50 is flexed, since the latch top 60 is fixed to the head restraint 28, the second end of the latch 50 may move, as described further herein and as shown in FIGS. 9 and 10.

Due to the spring-like nature of the latch 50, the latch 50 may be pre-loaded or biased to rotate about the second axis 62 and move back toward the projection 52, thereby engaging the notch 58 and the projection 52 into the locked position 44. Accordingly, when the folding mechanism 26 is rotated such that the notch 58 and the projection 52 are close or in contact, the folding mechanism 26 may automatically move back into the locked position 44 by moving the notch 58 back around the projection 52. The bias force of the latch 50 to move toward the projection 52 eliminates the need for a separate lock spring.

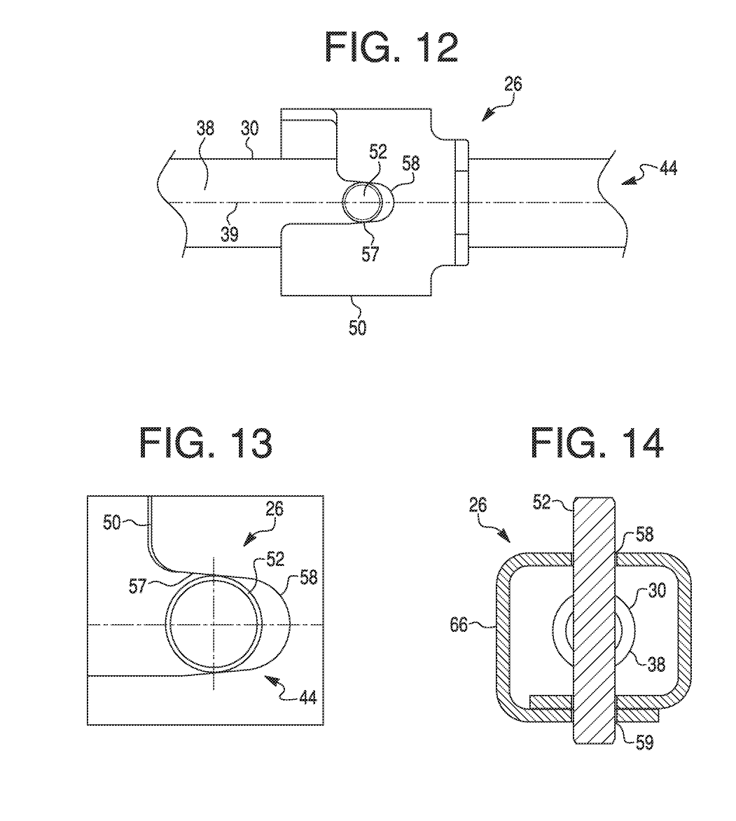

As shown in FIGS. 12 and 13, the width of the notch 58 may be approximately equal to the diameter of the projection 52 to in order to provide a tight and secure fit, as well as to remove any looseness between the head restraint 28 and the head restraint tube 30 once the latch 50 is in the locked position 44. The notch 58 may also have a lock angle 57 in order to provide an even more secure fit. For example, the sides of the notch 58 may not be parallel and may be slightly angled inward toward the back side of the notch 58. According to another embodiment, the opening to the notch 58 (i.e. where the projection 52 is inserted into) may be slightly narrower than the end of the notch 58 to secure the projection 52 into the notch 58 and prevent the projection 52 from slipping out and unlocking the folding mechanism 26. Due to the geometry to the projection 52 and the notch 58, the projection 52 may be press-fit into the notch 58 in the locked position 44 in order to provide a secure attachment.

As shown in FIG. 14, the latch 50 may include multiple notches, such as the upper notch 58 and a lower notch 59. Since the projection 52 may extend through the support member 38, both of the notches 58 and 59 may be engaged and locked with the projection 52 on either side of the support member 38 in the locked position 44.

The notches 58 and 59 may be shaped and sized similarly or differently according to the desired configuration. For example, one of the notches may have a tighter lock with the projection 52 in the locked position 44 (the primary lock) and the other of the notches may have a looser lock with the projection 52 in the locked position 44 (the secondary lock) to further prevent any looseness. Either the upper notch 58 or the lower notch 59 may optionally be used as the primary lock for the projection 52.

According to one embodiment, the upper notch 58 may optionally function as the primary lock and the lower notch 59 may optionally function as the secondary lock, providing slightly more clearance for the projection 52 when the latch 50 is locked. Accordingly, the lower notch 59 may only contact the projection 52 during significant loading or strength testing.

It is anticipated that the folding mechanism 26 may have multiple notches 58 and/or the support member 38 may have multiple projections along their circumferences. Accordingly, the folding mechanism 26 may be locked into multiple different positions around the support member 38. It is further anticipated that the projections 52 may be located on the latch 50 and the notches 58 may be located along the support member 38.

According to another embodiment as shown in FIG. 15, the second end of the latch 50 may include position stops 68. The projection 52 may contact the position stops 68 on either side of the latch 50 while the folding mechanism 26 is in the unlocked position 45 to prevent the folding mechanism 26 from pivoting any farther in one direction.

The position stop 68 may be a projection or extension along the second end of the latch 50. While the latch 50 is not flexed or in the locked position, the position stop 68 may come into contact with the projection 52 upon rotation (e.g. rotating the notch 58 away from the projection 52).

The position stop 68 may be located along a different side around the support member 38 from the notch 58. Accordingly, when the head restraint 28 is rotated a particular number of degrees (such as, approximately)90° from where the notch 58 and projection 52 may meet, the projection 52 may hit the position stop 68 to stop the head restraint 28 from rotating any further. The position stops 68 may be used instead of additional notches 58 and may prevent the folding mechanism 26 from moving any further without locking the folding mechanism 26 into place.

According to another embodiment, the folding mechanism 26 may include a return spring 54 to help rotate the folding mechanism 26 (and, therefore, the head restraint 28) in a particular direction around the support member 38. As shown in FIG. 7, the return spring 54 may hook into the rear cover 34 (and/or the front cover 33), as well as the projection 52. The return spring 54 may be pre-loaded or bias the head restraint 28 to move in one direction with respect to the support member 38 (and, therefore, around the first axis 39). According to one embodiment, the return spring 54 may rotate the folding mechanism 26 forward into a folded position 46 (as shown in FIGS. 4A and 15) once the folding mechanism 26 is unlocked.

According to another embodiment as shown in FIGS. 16-29, the folding mechanism 26 may be at least partially overmolded. Accordingly, as shown in FIG. 16, the overmolded latch 70 may include an overmold 72 and an inner spring or support plate 74. The overmolded latch 70 may function similarly to the latch 50 and may include the various components, embodiments, benefits, and configurations of the latch 50 as described further herein. The overmolded latch 70 may be also used within the folding mechanism 26.

The overmold 72 and the support plate 74 may be constructed out of a variety of materials, including but not limited to plastic or metal. According to one embodiment, the overmold 72 may be plastic and the support plate 74 may be spring steel.

The latch 70 may also fit and move around the support member 38. Accordingly, the overmold 72 and the support plate 74 may include a clearance slot 92 for the support member 38 to be located within.

As shown in FIG. 19, the support plate 74 may be a substantially flat plate and may function as a lock spring by allowing the folding mechanism 26 to be flexed while moving into the unlocked position 45. The support plate 74 may flex within the overmold 72 in a similar manner to the latch 50. Accordingly, the first end of the support plate 74 (e.g. the latch top 80) may be fixed features within the covers 33 or 34. The second end of the support plate 74 may be around the support member 38 and may move relative to the support member 38 and the head restraint 28.

In order to attach with the overmold 72, the support plate 74 may include locating features 78. The locating features 78 may be used to locate the support plate 74 within the overmold 72 by mating with corresponding structures within the overmold 72. For example, the locating features 78 may be apertures that mate with posts in the overmold 72 and/or may be posts that mate with apertures in the overmold 72. Accordingly, the support plate 74 may support the overmold 72 and may be compatible with the plastic lock features.

As shown in FIGS. 17, 18, and 24, at least a portion of the support plate 74 may be substantially within or covered by the overmold 72, with the exception of a latch top 80 to connect with the head restraint 28. The overmold 72 may provide additional features to lock with the support member. For example, similar to the latch 50, the overmold 72 may include at least one notch 88 to interlock with the projection 52 on the support member 38, as shown in FIG. 16.

According to one embodiment, the overmold 72 may include a second notch 89 to interlock with the projection 52. The overmold 72 may also include molded position stops 68 on either side of the overmolded latch 70 to stop the folding mechanism 26 from pivoting past a certain point (such as the folded position 46) by contacting the projection 52.

According to anther embodiment as shown in FIG. 24, the overmold 72 may include locations, holes, or apertures 83 for pivot features, pins, or projections to fit within along the release pivot axis 82 of the overmolded latch 70. The pins or projections may extend from the covers 33 or 34 to support each side of the latch 70 during at least significant loading or strength testing. During normal operation, there may be clearance between the covers 33 and 34 and the latch 70.

According to another embodiment and as shown in FIG. 16, the overmold 72 may also include a push/pull post 84 and/or a pull point 90 to interact with the release mechanism 32 and to flex the latch 70, as shown in FIG. 16. The location of the push/pull post 84 and pull point 90 may vary along the overmolded latch 70. The pull point 90, as shown in FIGS. 18, 21, and 26, may be used with the release mechanism 32 (such as a cable release) to pull the latch 70 from the locked position 44 and away from the projection 52.

As shown in FIGS. 20-26 and 30A, the projection 52 is fit within at least the notch 88 of the latch 70 in the locked position 44 to prevent the folding mechanism 26 from rotating. As shown in FIGS. 22 and 23, the projection 52 may be firmly secured within the notch 88.

In order to unlock the latch 70 and move the folding mechanism 26 between the locked position 44 and the unlocked position 45, the latch 70 may be pushed or pulled (by the release mechanism 32), which flexes, bends, or pivots the latch about a pivot axis 82 and displaces the latch 70. With the displacement of the second end of the latch, the latch may release the projection 52 from the notch 88 within the overmold 72 and the projection may clear the notch 88, thereby unlocking the latch 70 and moving into the unlocked position 45, as shown in FIGS. 27, 28, and 30B.

Once the latch 70 is unlocked, the folding mechanism 26 may be rotated or pivot around the support member 38 into, for example, the folded position 46, as shown in FIGS. 29 and 30C. The spring 54 may help move the folding mechanism 26 in a particular direction along the first axis 39. The projection 52 may contact the folded position stops 86 on either side of the overmolded latch 70 to prevent the mechanism from pivoting past the folded position 46.

The folding mechanism 26 may be manufactured and assembled with a variety of different methods. According to one embodiment, the latch top 60 may be attached to an inner portion of the head restraint 28. The support member 38 may be inserted through a hole or aperture within the latch 50, such that the latch 50 may rotate around the support member 38 when in the unlocked position 45. The projection 52 may be moved or inserted into the notch 58 on the latch 50 to place the latch 50 in the locked position 44. The head restraint covers 33 and 34 may be attached together around the outside of at least the latch 50.

It is anticipated that the various embodiment and components described herein may be used in conjunction with each other and in variety of different configurations.

The embodiments disclosed herein a folding mechanism to be adjusted with a simplified folding mechanism. Besides those embodiments depicted in the figures and described in the above description, other embodiments of the present invention are also contemplated. For example, any single feature of one embodiment of the present invention may be used in any other embodiment of the present invention.

Given the disclosure of the prevent invention, one versed in the art would appreciate that there may be other embodiments and modifications within the scope and spirit of the invention. Accordingly, all modifications attainable by one versed in the art from the present invention within the scope and spirit of the present invention are to be included as further embodiments of the present invention.

What is claimed is:

1. A folding mechanism for a head restraint, comprising:
a support member having a first axis, wherein a projection projects outward from the support member; and
a latch attached to the head restraint and rotatable around the first axis, wherein the latch has a notch that can receive the projection,
wherein the latch is flexed to pivot a portion of the latch around a second axis in order to move between an unlocked position where the projection is not received in the notch such that the head restraint is rotatable around the support member, and a locked position where the projection is received in the notch such that the head restraint is not rotatable around the support member.

2. The folding mechanism of claim 1, wherein the latch is flexed relative to both the head restraint and the support member.

3. The folding mechanism of claim 1, wherein the first axis and the second axis are approximately perpendicular.

4. The folding mechanism of claim 1, wherein a top portion of the latch is statically attached to the head restraint.

5. The folding mechanism of claim 1, wherein the latch is biased toward the projection.

6. The folding mechanism of claim 1, further comprising a release mechanism, wherein the release mechanism pushes or pulls the latch to cause the latch to flex.

7. The folding mechanism of claim 1, wherein a width of the notch is approximately equal to the diameter of the projection and the projection is press-fit into the notch in the locked position to remove looseness between the notch and the projection.

8. The folding mechanism of claim 1, further comprising at least one position stop, wherein the at least one position stop contacts the at least one projection in the unlocked position and prevents the folding mechanism from rotating further in one direction.

9. The folding mechanism of claim 1, wherein the projection projects from opposite sides of the support member and the latch has at least two notches along opposite sides of the support member.

10. The folding mechanism of claim 1, further comprising a spring attached to the head restraint and the projection or support member, wherein the spring biases the head restraint in one direction with respect to the support member.

11. The folding mechanism of claim 1, wherein the latch is spring steel.

12. The folding mechanism of claim 1, wherein the latch comprises an overmold and an inner support plate, wherein the notch is within the overmold and the support plate is spring steel.

13. A head restraint assembly movable with respect to a seat, comprising:
a head restraint;
at least one head restraint tube extending from the seat;
a support member attached to the at least one head restraint tube and having a first axis, wherein a projection projects outward from the support member; and
a latch attached to the head restraint and rotatable around the first axis, wherein the latch has a notch that can receive the projection,
wherein the latch is flexed to pivot a portion of the latch around a second axis in order to move between an unlocked position where the projection is not received in the notch such that the head restraint is rotatable around the support member, and a locked position where the projection is received in the notch such that the head restraint is not rotatable around the support member.

14. The head restraint assembly according to claim 13, further comprising a release mechanism, wherein activation of the release mechanism flexes the latch.

15. The head restraint assembly according to claim 13, wherein the first pivot axis and the second pivot axis are approximately perpendicular.

16. The head restraint assembly according to claim 13, wherein a top portion of the latch is statically attached to the head restraint.

17. The head restraint assembly according to claim 13, wherein the latch is biased toward the projection.

18. The head restraint assembly according to claim 13, further comprising at least one position stop, wherein the at least position stop contacts the projection and prevents the folding mechanism from rotating further in one direction.

19. The head restraint assembly of claim 13, wherein the latch allows the head restraint to rotate with respect to the head restraint tube or to rotate with the head restraint tube with respect to the vehicle seat.

20. A method of manufacturing a folding mechanism for adjusting a head restraint relative to a seat comprising:
attaching a top portion of the latch to the head restraint;
inserting a support member of a head restraint into a hole within a latch;
moving a projection on the support member into a notch on the latch; and
attaching a head restraint cover around at least the latch.
